(19) United States
(12) Patent Application Publication
(10) Pub. No.: US 2012/0136472 A1
(43) Pub. Date: May 31, 2012

(54) DUAL-ARM TYPE ROBOTIC ARM AND ITS METHOD OF TRANSPORTING PANELS

(76) Inventors: Yan-ze Li, Shenzhen (CN); Chengming He, Shenzhen (CN)

(21) Appl. No.: 13/000,585

(22) PCT Filed: Dec. 6, 2010
(86) PCT No.: PCT/CN2010/079448

§ 371 Date: May 10, 2011

(30) Foreign Application Priority Data
Nov. 25, 2010 (CN) 201010559558.5

(51) Int. Cl. B25J 9/02; B25J 15/06

(52) U.S. Cl. 700/114; 901/40

(57) ABSTRACT

The present invention provides a dual-arm type robotic arm and its method of transporting panels, and mainly has a first robotic arm and a second robotic arm which simultaneously extend into a processing equipment. When the second robotic arm takes out a second panel from the processing equipment, the first robotic arm simultaneously executes a stabilization operation and executes a fastening-suction release operation of a carried first panel. Then, the first robotic arm is lowered for placing the first panel in the processing equipment. Thus, the present invention can prevent from occurring a breakage risk of the first panel during being placed, and save the operation time during the first robotic arm waits to be stable and then release the fastening-suction.

### FIELD OF THE INVENTION

The present invention relates to a dual-arm type robotic arm and its method of transporting panels, and more particularly to a dual-arm type robotic arm and its method of transporting panels for reducing the total operation time.

### BACKGROUND OF THE INVENTION

In a traditional process of liquid crystal display (LCD) panels, it comprises a front-end array process, a mid-end cell process and a back-end modulation process, wherein the front-end array process is used to produce thin-film transistor (TFT) substrates and color filter (CF) substrates; the mid-end cell process is used to combine the TFT substrate with the CF substrate, then fill liquid crystal into a space therebetween, and cut to form panels with a suitable product size; and the back-end modulation process is used to execute an installation process of the combined panel, a backlight module, a panel driver circuit, an outer frame and etc. In the front-end array process, firstly cleaning a feed-in glass substrate, and then coating a thin film of target material, which is metal (such as aluminum-chromium, Al—Cr) or semiconductor thin-film (such as indium tin oxide, ITO), thereon, so as to be used as a substrate having conductive circuits. Then, the foregoing thin film is evenly coated with a photoresist, and exposed by a photomask finishing micro-photolithography. After the exposure and development process of the photoresist is finished, the conductive circuits can be obtained. Then, an etching solution is used to remove unnecessary thin-film of metal or semiconductor, and thus only the thin-film of conductive circuits is remained. Finally, a stripper solution is used to remove the photoresist on the conductive circuits. After the foregoing steps may be repeated about 5-8 times for each thin-film of metal or semiconductor, the TFT substrate can be finished.

However, during the front-end array process, the substrate must be processed by various different equipments, such as a cleaning equipment, an exposure machine, a development line, a photoresist coating line machine, a sealant printing equipment, a glass combination equipment, a hot pressing equipment, a spraying equipment and etc., wherein a processed or to-be-processed semi-finished substrate product is generally picked and placed by a robotic arm. A traditional dual-arm type robotic arm can execute actions of exchanging semi-finished substrate products, as follows: extending a lower robotic arm into a processing equipment for taking out a processed substrate, and then retracting the lower robotic arm to leave the processing equipment for returning to an original position. When the lower robotic arm is retracted to leave the processing equipment, an upper robotic arm is extended into the processing equipment. Then, the upper robotic arm is lowered for placing a to-be-processed substrate in the processing equipment, so that a cycle of picking-and-placing action is finished. In operation, only when the robotic arms are stopped to maintain stable, they can execute a next action. During operation, the upper and lower robotic arms use vacuum suckers to fasten substrates, but the upper robotic arm must firstly maintain stable (from a motion status to a stationary status) and then can break vacuum to release the substrate. Thus, before the upper robotic arm releases the substrate, it must wait a period of time. After the upper robotic arm is stable and not shaken, it can be lowered and simultaneously break vacuum. As a result, in the traditional method, because the upper robotic arm needs to wait a period of time to maintain stable, the total operation time of picking and placing the substrate by the dual-arm type robotic arm will be increased.

As a result, it is necessary to provide a dual-arm type robotic arm and its method of transporting panels to solve the problems existing in the conventional technologies, as described above.

### SUMMARY OF THE INVENTION

A primary object of the present invention is to provide a method of transporting panels by a dual-arm type robotic arm, which controls a first robotic arm and a second robotic arm to simultaneously extend into a processing equipment; and when the second robotic arm takes out a second panel from the processing equipment, the first robotic arm simultaneously executes a stabilization operation and executes a fastening-suction release operation of a carried first panel. Thus, the present invention can prevent from occurring a breakage risk of the first panel during being placed, and save the operation time during the first robotic arm waits to be stable and then release the fastening-suction by breaking vacuum, so as to further reduce the total operation time and relatively enhance the productivity and yield.

A secondary object of the present invention is to provide a dual-arm type robotic arm, wherein the first robotic arm simultaneously executes a stabilization operation and executes a fastening-suction release operation of a carried first panel when the second robotic arm takes out a second panel from the processing equipment. Thus, the speed for lowering the first robotic arm and placing the first panel can be increased without affecting the yield, so that the operation time of transporting panels by the dual-arm type robotic arm can be further reduced and thus the entire productivity can be enhanced.

To achieve the above object, the present invention provides a method of transporting panels by a dual-arm type robotic arm, which is applied to a process of a liquid crystal display (LCD) panels, and the method comprises the following steps of:

(a) preparing a first robotic arm and a second robotic arm, and carrying a first panel by the first robotic arm;

(b) simultaneously extending the first robotic arm and the second robotic arm into a processing equipment, wherein the second robotic arm reaches the bottom of an operation position, and the operation position is placed with a second panel;

(c) lifting the second robotic arm to carry the second panel;

(d) moving the second robotic arm and the second panel to exit the processing equipment;

(e) lowering the first robotic arm and placing the first panel on the operation position; and

(f) moving the first robotic arm to exit the processing equipment;

wherein during the step (c) and the step (d), the first robotic arm simultaneously executes a stabilization operation.

In one embodiment of the present invention, after the first robotic arm executes the stabilization operation, further comprising: executing a fastening-suction release operation of the first panel.

In one embodiment of the present invention, an upper surface of the first robotic arm has at least one vacuum sucker, and the at least one vacuum sucker provides a fastening suction to fasten the first panel.

In one embodiment of the present invention, an upper surface of the second robotic arm has at least one vacuum sucker, and the at least one vacuum sucker provides a fastening suction to fasten the second panel.

In one embodiment of the present invention, during the step (c) and the step (d), breaking vacuum of the at least one vacuum sucker of the first robotic arm, so as to finish the fastening-suction release operation of the first panel.

In one embodiment of the present invention, during lowering the first robotic arm, simultaneously lowering the second robotic arm.

In one embodiment of the present invention, during lifting the second robotic arm, simultaneously lifting the first robotic arm.

Furthermore, the present invention further provides a dual-arm type robotic arm, comprising:

a first robotic arm carrying a first panel, extending into a processing equipment which includes an operation position carrying a second panel, placing the first panel on the operation position, and exiting the processing equipment; and

a second robotic arm simultaneously extending into the processing equipment together with the first robotic arm, carrying the second panel in the processing equipment, and exiting the processing equipment after carrying the second panel; wherein the first robotic arm further executes a stabilization operation during the second robotic arm carries the second panel and exits the processing equipment.

In one embodiment of the present invention, the first robotic arm executes a fastening-suction release operation of the first panel after executing the stabilization operation.

In one embodiment of the present invention, an upper surface of the first robotic arm has at least one vacuum sucker, and the at least one vacuum sucker provides a fastening suction to fasten the first panel.

In one embodiment of the present invention, an upper surface of the second robotic arm has at least one vacuum sucker, and the at least one vacuum sucker provides a fastening suction to fasten the second panel.

In one embodiment of the present invention, each of the first robotic arm and the second robotic arm has a fork-like carrying platform.

In one embodiment of the present invention, vacuum of the at least one vacuum sucker of the first robotic arm is broken during the second robotic arm carries the second panel and exit the processing equipment, so as to finish the fastening-suction release operation of the first panel.

### DESCRIPTION OF THE DRAWINGS

FIG. 1 to FIG. 6 are schematic views of actions of transporting panels by a dual-arm type robotic arm according to a preferred embodiment of the present invention; and

FIG. 7 is a flowchart of a method of transporting panels by the dual-arm type robotic arm according to the preferred embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings.

A method of transporting panels by dual-arm type robotic arm according to the present invention is mainly applied to a process of liquid crystal display (LCD) panels, especially a front-end array process of LCD panels, and uses robotic arms to pick and place substrates from/on various different processing equipments. The front-end array process of LCD panels can be referring to the description of the background of the invention, and thus omitted herein.

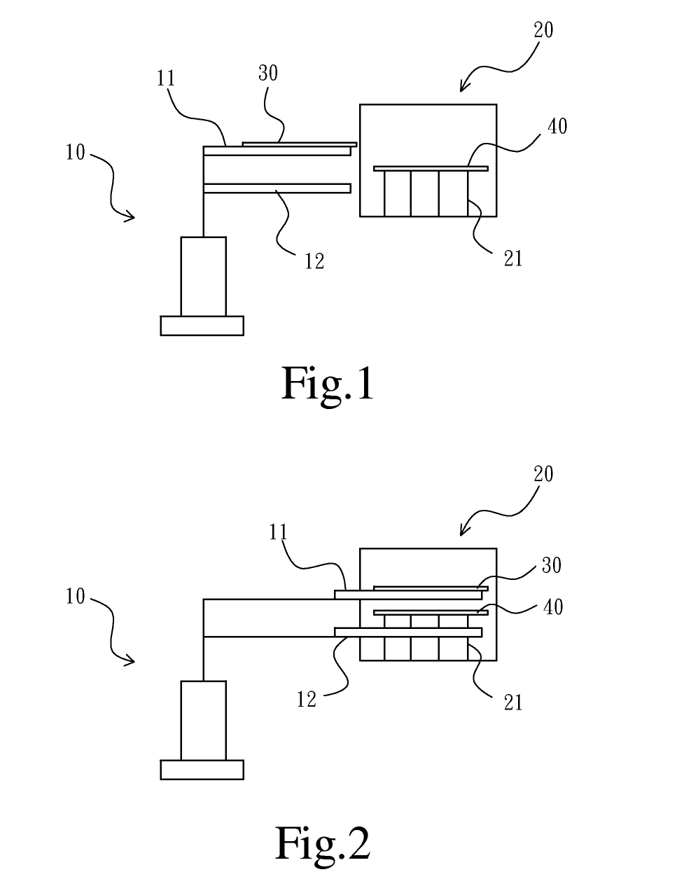

Referring now to FIG. 1, FIG. 1 is a schematic view of an action of transporting panels by a dual-arm type robotic arm according to a preferred embodiment of the present invention. As shown in FIG. 1, a main body of a dual-arm type robotic arm 10 is a column-like base, and the dual-arm type robotic arm 10 comprises a first robotic arm 11 and a second robotic arm 12, wherein the first robotic arm 11 and the second robotic arm 12 use a plurality of joints and a plurality of servo-mechanisms to independently operate (and be generally controlled by a computer software). Each of the first robotic arm 11 and the second robotic arm 12 has a fork-like carrying platform, and works in a manner similar to a fork-lift truck, wherein the fork-like carrying platform can be extended to a position below/under an object and then lifted to carry/load the object; or reversely operate to unload.

Furthermore, an upper surface of each of the first robotic arm 11 and the second robotic arm 12 has at least one vacuum sucker (not-shown), and the at least one vacuum sucker provides a fastening suction function to fasten the carried/loaded object.

Moreover, in the method of transporting panels by dual-arm type robotic arm according to the present invention, except for the dual-arm type robotic arm 10, it further needs a processing equipment 20, a first panel 30 and a second panel 40, wherein the processing equipment 20 can be a close/sealed type or non-close/sealed type processing equipment, such as a cleaning equipment, an exposure machine, a development line, a photoresist coating line machine, a sealant printing equipment, a glass combination equipment, a hot pressing equipment, a spraying equipment and etc., used in the front-end array process of LCD panel.

In addition, the processing equipment 20 comprises at least one open side (unlabeled) and an operation position 21, wherein the open side can be fixed or temporarily opened, so that the first robotic arm 11 and the second robotic arm 12 can extend into the processing equipment 20 to operate. The operation position 21 is a carrier frame having a hollow bottom and a partially open top, so that the first robotic arm 11 and the second robotic arm 12 can extend therein (or retract out thereof) from the open side; or pass through the operation position 21 from top to bottom. The present invention mainly uses the second robotic arm 12 and the first robotic arm 11 of the dual-arm type robotic arm 10 to take out the second panel 40 in the processing equipment 20 and place the first panel 30.

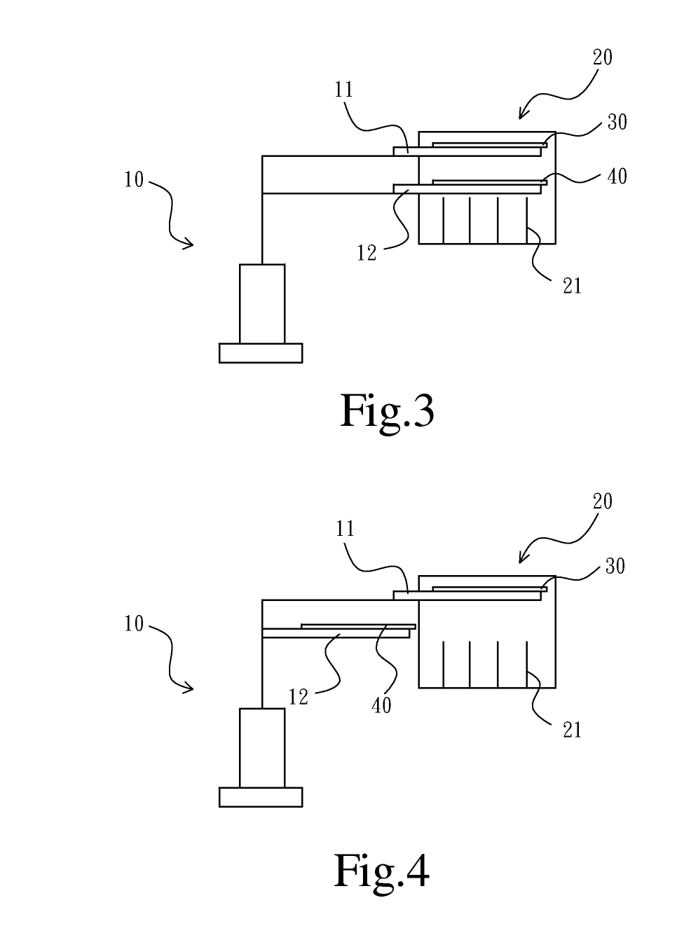

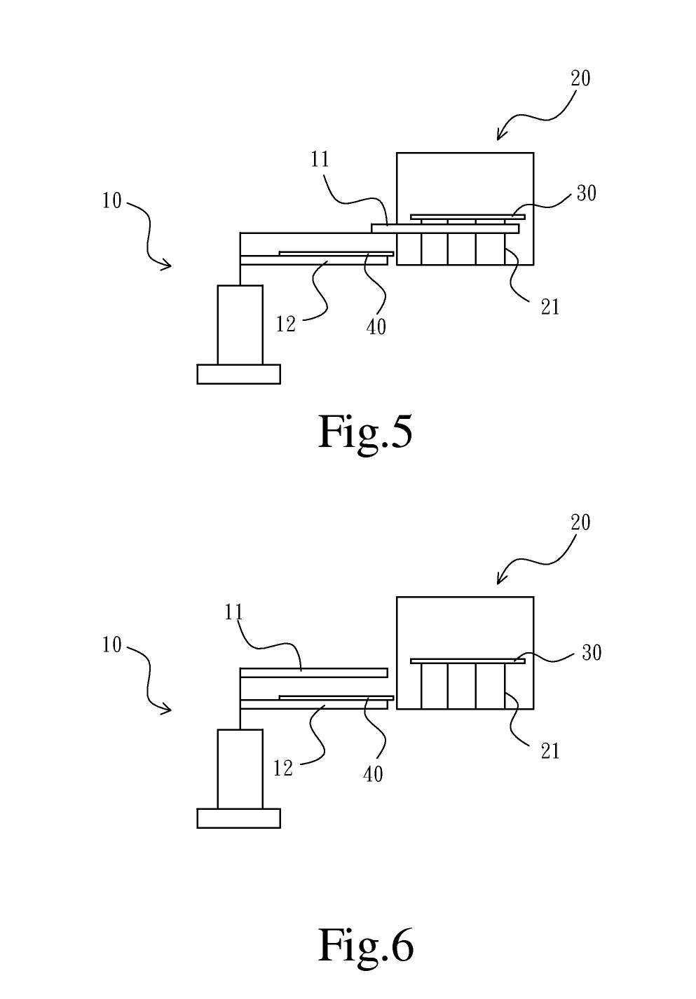

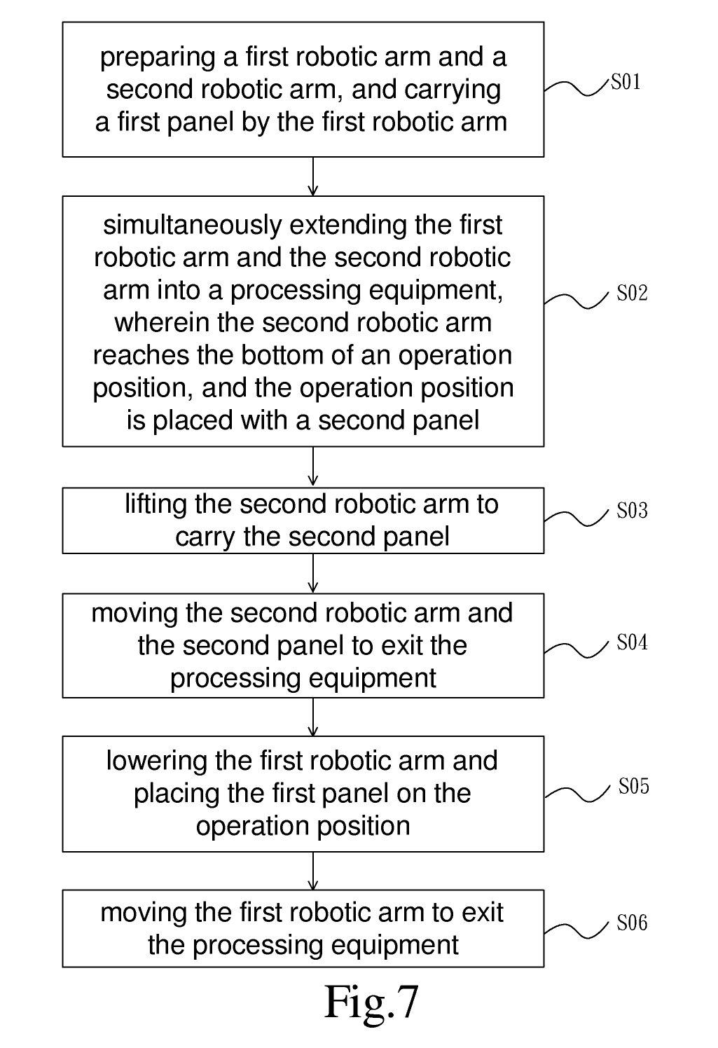

Referring now to FIGS. 1 to 7, in the preferred embodiment of the present invention, FIG. 1 to FIG. 6 are schematic views of continuous actions of transporting panels by a dual-arm type robotic arm according to a preferred embodiment of the present invention; and FIG. 7 is a flowchart of a method of transporting panels by the dual-arm type robotic arm according to the preferred embodiment of the present invention. As shown in FIG. 7, the method of transporting panels by the dual-arm type robotic arm according to the preferred embodiment of the present invention comprises the following steps of:

(a) Preparing the first robotic arm 11 and the second robotic arm 12, and carrying the first panel 30 by the first robotic arm 11 (i.e. step S01). At this time, the second robotic arm 12 is standby, and the upper surface of the first robotic arm 11 starts to vacuumize to fasten the first panel 30.

(b) Simultaneously extending the first robotic arm 11 and the second robotic arm 12 into the processing equipment 20, wherein the second robotic arm 12 reaches the bottom of the operation position 21, and the operation position 21 is placed with the second panel 40 (i.e. step S02). At this time, the first robotic arm 11 carries the first panel 30 and located above the operation position 21 about a suitable distance.

(c) Lifting the second robotic arm 12 to carry the second panel 40 (i.e. step S03). At this time, the vacuum sucker on the upper surface of the second panel 40 can start to vacuumize for fastening the second panel 40. Meanwhile, the first robotic arm 11 can execute a stabilization operation, and the vacuum sucker thereof can execute a fastening-suction release operation of the carried/loaded first panel 30 after the first panel 30 is stable.

During lifting the second robotic arm 12, the first robotic arm 11 can be simultaneously lifted. During the second robotic arm 12 carries the second panel 40, the first robotic arm 11 can simultaneously execute the stabilization operation. It can be understood that the first robotic arm 11 also can be kept on a fixed horizontal position during lifting the second robotic arm 12, wherein it only needs to adjust to have a sufficient height difference between the first robotic arm 11 and the second robotic arm 12 before the step (b).

(d) Moving the second robotic arm 12 and the second panel 40 to exit the processing equipment 20 (i.e. step S04). At this time, the vacuum sucker of the first robotic arm 11 can finish breaking vacuum.

(e) Lowering the first robotic arm 11 and placing the first panel 30 on the operation position 21 (i.e. step S05). During lowering the first robotic arm 11, the second robotic arm 12 can be simultaneously lowered.

(f) Moving the second robotic arm 12 to exit the processing equipment 20 (i.e. step S06).

As described in the above steps (a) to (f), the first robotic arm 11 and the second robotic arm 12 simultaneously extend into the processing equipment 20. During the step (c) and the step (d) (i.e. when the second robotic arm 12 takes out the second panel 40 in the processing equipment 20), the first robotic arm 11 simultaneously executes a stabilization operation (i.e. from a motion status to a stationary status) and executes a fastening-suction release operation of the carried first panel 11. Thus, before executing the step (e) (i.e. before lowering the first robotic arm 11 and placing the first panel 30 on the operation position 21), the vacuum sucker on the first robotic arm 11 has finished breaking vacuum to finish the fastening-suction release operation. As a result, the present invention can prevent from occurring a breakage risk of the first panel 30 during being placed, save the operation time during the first robotic arm 11 waits to be stable and then release the fastening-suction by breaking vacuum, so as to further reduce the total operation time and relatively enhance the productivity and yield.

Furthermore, in a traditional method of transporting panels by a dual-arm type robotic arm, the vacuum breaking operation is executed during lowering. Once the output value of the upper robotic arm is excessive (lowering too fast), it may cause that the vacuum sucker of the upper robotic arm can not completely break vacuum during placing the substrate (i.e. the remaining suction force of the vacuum sucker still fastens the substrate). As a result, when the substrate is placed on the operation position (such as a frame) in the processing equipment, it may cause that the substrate is impacted by the operation position to generate broken defects, so as to substantially affect the processing yield. According to the method of transporting panels by a dual-arm type robotic arm of the present invention, before the first panel 30 is placed on the operation position 21, the vacuum sucker on the first robotic arm 11 has finished the vacuum breaking operation. Thus, the output value (speed) of the first robotic arm 11 for lowering and placing the first panel 30 can be increased, so as to further reduce the operation time of transporting panels by the dual-arm type robotic arm and relatively increase the productivity.

In addition, the first robotic arm 11 of the present invention is preferably disposed above the second robotic arm 12, but the present invention is not limited thereto, wherein the user also can arrange the relative position and distance of the first robotic arm 11 and the second robotic arm 12 according to actual needs.

Besides, the method of transporting panels by a dual-arm type robotic arm of the present invention is preferably applied to substrates of the front-end array process of LCD panel, and thus each of the first robotic arm 11 and the second robotic arm 12 of the present invention preferably has a fork-like carrying platform, but the present invention is not limited thereto, wherein the method of transporting panels by a dual-arm type robotic arm of the present invention also can be applied to other processes of LCD panel, while carrying platforms of the first robotic arm 11 and the second robotic arm 12 can be other types.

As described above, in the traditional method of transporting panels by the traditional dual-arm type robotic arm, the upper robotic arm must firstly wait a period of time to then break vacuum, resulting in increasing the total operation time of picking and placing the substrate by the robotic arm, and the substrate may be broken due to incompletely breaking vacuum during the robotic arm is lowered. In contrast, according to the method of transporting panels by the dual-arm type robotic arm of the present invention, the first robotic arm 11 and the second robotic arm 12 are simultaneously extended into the processing equipment 20; and when the second robotic arm 12 takes out the second panel 40 from the processing equipment 20, the first robotic arm 11 can simultaneously execute a stabilization operation and executes a fastening-suction release operation (i.e. breaking vacuum operation) of the carried first panel 30. Thus, the present invention can prevent from occurring a breakage risk of the first panel 30 during being placed, and save the operation time during the first robotic arm 11 waits to be stable and then release the fastening-suction by breaking vacuum, so as to further reduce the total operation time and relatively enhance the productivity and yield.

The present invention has been described with a preferred embodiment thereof and it is understood that many changes and modifications to the described embodiment can be carried out without departing from the scope and the spirit of the invention that is intended to be limited only by the appended claims.

1. A method of transporting panels by a dual-arm type robotic arm, characterized in that: the method comprises the following steps of:
(a) preparing a first robotic arm and a second robotic arm, and carrying a first panel by the first robotic arm;
(b) simultaneously extending the first robotic arm and the second robotic arm into a processing equipment, wherein the second robotic arm reaches the bottom of an operation position, and the operation position is placed with a second panel;
(c) lifting the second robotic arm to carry the second panel;
(d) moving the second robotic arm and the second panel to exit the processing equipment;
(e) lowering the first robotic arm and placing the first panel on the operation position; and
(f) moving the first robotic arm to exit the processing equipment;
wherein during the step (c) and the step (d), the first robotic arm simultaneously executes a stabilization operation, and executes a fastening-suction release operation of the first panel after the stabilization operation; and wherein an upper surface of the first robotic arm has at least one vacuum sucker, and the at least one vacuum sucker provides a fastening suction to fasten the first panel.

2. The method of transporting panels by the dual-arm type robotic arm according to claim 1, characterized in that: during the step (c) and the step (d), breaking vacuum of the at least one vacuum sucker of the first robotic arm, so as to finish the fastening-suction release operation of the first panel.

3. The method of transporting panels by the dual-arm type robotic arm according to claim 1, characterized in that: an upper surface of the second robotic arm has at least one vacuum sucker, and the at least one vacuum sucker provides a fastening suction to fasten the second panel.

4. A method of transporting panels by a dual-arm type robotic arm, characterized in that: the method comprises the following steps of:
(a) preparing a first robotic arm and a second robotic arm, and carrying a first panel by the first robotic arm;
(b) simultaneously extending the first robotic arm and the second robotic arm into a processing equipment, wherein the second robotic arm reaches the bottom of an operation position, and the operation position is placed with a second panel;
(c) lifting the second robotic arm to carry the second panel;
(d) moving the second robotic arm and the second panel to exit the processing equipment;
(e) lowering the first robotic arm and placing the first panel on the operation position; and
(f) moving the first robotic arm to exit the processing equipment;
wherein during the step (c) and the step (d), the first robotic arm simultaneously executes a stabilization operation.

5. The method of transporting panels by the dual-arm type robotic arm according to claim 4, characterized in that: after the first robotic arm executes the stabilization operation, further comprising: executing a fastening-suction release operation of the first panel.

6. The method of transporting panels by the dual-arm type robotic arm according to claim 4, characterized in that: an upper surface of the first robotic arm has at least one vacuum sucker, and the at least one vacuum sucker provides a fastening suction to fasten the first panel.

7. The method of transporting panels by the dual-arm type robotic arm according to claim 6, characterized in that: during the step (c) and the step (d), breaking vacuum of the at least one vacuum sucker of the first robotic arm, so as to finish the fastening-suction release operation of the first panel.

8. The method of transporting panels by the dual-arm type robotic arm according to claim 4, characterized in that: an upper surface of the second robotic arm has at least one vacuum sucker, and the at least one vacuum sucker provides a fastening suction to fasten the second panel.

9. The method of transporting panels by the dual-arm type robotic arm according to claim 4, characterized in that: during lowering the first robotic arm, simultaneously lowering the second robotic arm.

10. The method of transporting panels by the dual-arm type robotic arm according to claim 4, characterized in that: during lifting the second robotic arm, simultaneously lifting the first robotic arm.

11. A dual-arm type robotic arm, characterized in that: comprising:
a first robotic arm carrying a first panel, extending into a processing equipment which includes an operation position carrying a second panel, placing the first panel on the operation position, and exiting the processing equipment; and
a second robotic arm simultaneously extending into the processing equipment together with the first robotic arm, carrying the second panel in the processing equipment, and exiting the processing equipment after carrying the second panel;
wherein the first robotic arm further executes a stabilization operation during the second robotic arm carries the second panel and exits the processing equipment.

12. The dual-arm type robotic arm according to claim 11, characterized in that: the first robotic arm executes a fastening-suction release operation of the first panel after executing the stabilization operation.

13. The dual-arm type robotic arm according to claim 11, characterized in that: an upper surface of the first robotic arm has at least one vacuum sucker, and the at least one vacuum sucker provides a fastening suction to fasten the first panel.

14. The dual-arm type robotic arm according to claim 11, characterized in that: an upper surface of the second robotic arm has at least one vacuum sucker, and the at least one vacuum sucker provides a fastening suction to fasten the second panel.

15. The dual-arm type robotic arm according to claim 11, characterized in that: each of the first robotic arm and the second robotic arm has a fork-like carrying platform.

16. The dual-arm type robotic arm according to claim 13, characterized in that: vacuum of the at least one vacuum sucker of the first robotic arm is broken during the second robotic arm carries the second panel and exit the processing equipment, so as to finish the fastening-suction release operation of the first panel.
